(19) United States
(12) Patent Application Publication
(10) Pub. No.: US 2024/0419209 A1
(43) Pub. Date: Dec. 19, 2024

(54) LOW POWER CLOCK MULTIPLEXER IN MICROCONTROLLER WITH SELECTABLE POWER DOMAIN OUTPUT

(71) Applicant: Cypress Semiconductor Corporation, San Jose, CA (US)

(72) Inventor: Jiawei Liang, Futian District (CN)

(73) Assignee: Cypress Semiconductor Corporation, San Jose, CA (US)

(21) Appl. No.: 18/335,009

(22) Filed: Jun. 14, 2023

(51) Int. Cl. G06F 1/08; G06F 1/10

(52) U.S. Cl. CPC G06F 1/08; G06F 1/10

(57) ABSTRACT

Systems and methods described herein fan out a source clock signal within the MCU to produce a plurality of clock signals. The systems and methods distribute the plurality of clock signals to a plurality of input/output (I/O) groups within the MCU, wherein each of the plurality of VO groups correspond to a different one of a plurality of power domains of the MCU. The systems and method provide the plurality of clock signals to a plurality of peripherals coupled to the plurality of I/O groups.

### TECHNICAL FIELD

Aspects of the present disclosure generally relate to computing device clock management, and more particularly, to fanning out clock signals to different power domains using a microcontroller.

### BACKGROUND

Computing devices may use multiple power domains to control power consumption of various components. A power domain is a grouping of components or subsystems that share a common power supply and may be managed as a single unit in terms of power management. Power domains allow for granular power management based on operational requirements and resource utilization of each power domain. By selectively powering on or off specific power domains, energy consumption can be optimized, leading to extended battery life, and improved overall power efficiency.

Another approach to reduce power consumption involves using multiple clock domains, such as a main clock domain and a low power clock domain. A low power clock domain uses a low power clock, which is typically a low frequency clock that is designed to operate with minimal power consumption. Low power clocks usually enable the computing device to have different operating modes to conserve energy, such as deep sleep mode. In a deep sleep mode, the computing device may rely on the low power clock to keep track of time, function as a watchdog timer, or a combination thereof. The low power clock typically operates at a lower frequency than the computing device's main clock and consumes little power.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for fanning out a source clock signal to multiple input/output (I/O) groups corresponding to multiple power domains, in accordance with some embodiments of the present disclosure.

FIG. 2 is a block diagram that illustrates an example system for fanning out multiple source clock signals in multiple clock domains to multiple I/O groups corresponding to multiple power domains, in accordance with some embodiments of the present disclosure.

FIG. 3 is a block diagram that illustrates an example system that includes signal boosters to adjust fanned out clock signals coupled to peripherals, in accordance with some embodiments of the present disclosure.

FIG. 4 is a flow diagram of a method for fanning out a source clock signal to multiple I/O groups corresponding to multiple power domains, in accordance with some embodiments of the present disclosure.

FIG. 5 is a block diagram of an example communication device that may perform one or more of the operations described herein, in accordance with some embodiments of the present disclosure.

### DETAILED DESCRIPTION

As discussed above, computing devices may use power domains, clock domains, or a combination thereof to reduce overall power consumption. A challenge found with implementing multiple power domains with multiple clock domains is that each power domain requires a separate clock source to be compatible with the power domain voltage levels. For example, if a computing device has power domains for supply voltages of 3.3V, 1.8V, and 1.2V, then the computing device also requires a low power clock source for the 3.3V, 1.8V, and 1.2V power domains. Unfortunately, each low power clock source increases the bill of materials (BOM) cost of the computing device. The BOM cost is the total cost of all the components used in a computing device, including the microcontroller, sensors, wireless communication modules, battery, printed circuit board (PCB), and other components.

In addition, each low power clock source requires space on the PCB. An important factor in PCB design is to reduce complexity by minimizing the number of components on the PCB. The fewer the number of components on the PCB, the simpler the design, and the lower the overall cost. Unfortunately, installing multiple low power clock sources on the PCB increases the size of the PCB and, in turn, increases the BOM cost.

The present disclosure addresses the above-noted and other deficiencies by using an electronic circuit within a microcontroller unit (MCU) to produce multiple clock signals from a source clock signal and fan out the multiple clock signals to multiple power domains. The method distributes the multiple clock signals to multiple input/output (I/O) groups within the MCU. Each one of the multiple I/O groups correspond to a different power domain. The method then provides the multiple clock signals to multiple peripherals coupled to the multiple I/O groups operating in the multiple power domains.

In some embodiments, the source clock signal is a low power clock and each one of the multiple clock signals operate as a low power clock to one or more of the multiple peripherals while operating a low power state. In some embodiments, each one of the multiple power domains are based on specifications corresponding to the multiple peripherals.

In some embodiments, the method uses a first source clock signal and a second source clock signal to produce multiple first clock signals and multiple second clock signals, respectively. The method distributes the multiple first clock signals and the multiple second clock signals to the multiple I/O groups operating in the multiple power domains, and provides the multiple first clock signals and the multiple second clock signals to the multiple peripherals coupled to the multiple I/O groups.

In some embodiments, the method turns off power to a first peripheral, and then turns off one of the multiple clock signals corresponding to the first peripheral in response to turning off the power to the first peripheral. In some embodiments, the MCU includes a multiplexer to fan out the source clock signal to produce the multiple clock signals. In some embodiments, the source clock signal is generated external to the MCU.

As discussed herein, the present disclosure provides an approach that improves the operation of a computer system by simplifying clock domain management using an MCU. In addition, the present disclosure provides an improvement to the technological field of computing devices by reducing the BOM costs of computing devices through reducing the number of clock sources and reducing the size and complexity of the PCB.

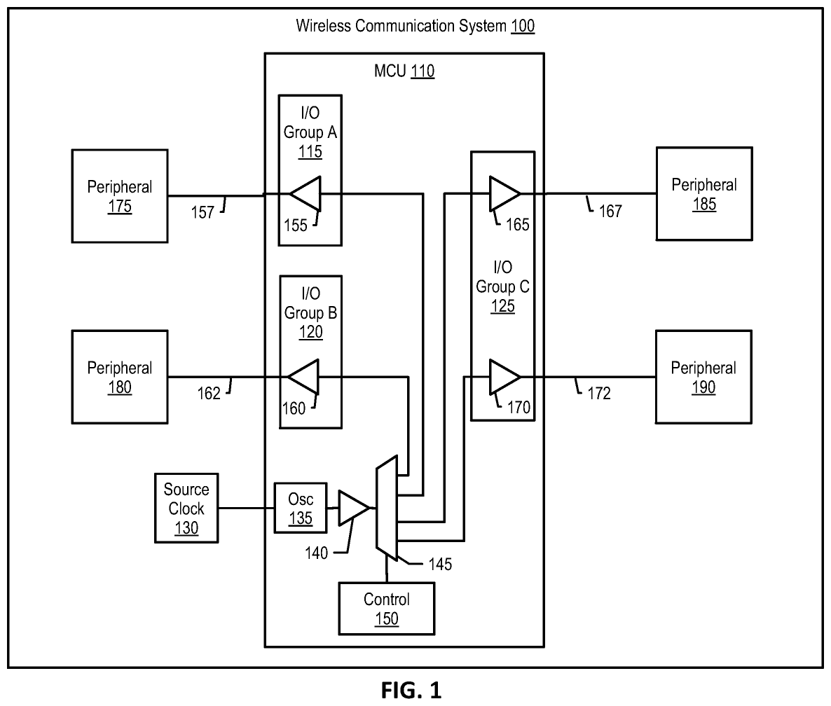

FIG. 1 is a block diagram that illustrates an example system for fanning out a source clock signal to multiple input/output (I/O) groups corresponding to multiple power domains, in accordance with some embodiments of the present disclosure.

Wireless communication system 100 includes microcontroller unit (MCU) 110, which includes multiple I/O groups 115, 120, and 125 to accommodate different power domains corresponding to peripherals 175, 180, 185, and 190. For example, the power domains may correspond to a 3.3 V VDD, a 1.8V VDD, and a 1.2 V VDD. In some embodiments, the power domains may correspond to 1.7V-5.5V VDD, 3.0V VDD, 3,4V VDD, or other voltage levels/ranges. In some embodiments, I/O groups 115, 120, and 125 couple to GPIO (General Purpose Input/Output) pins that enable MCU 110 to couple to peripherals 175, 180, 185, and 190 and perform digital input and output operations. GPIO pins can be used to interface with a wide range of peripherals, such as a GPS device, an Image Signal Processor (ISP), a WiFi/Bluetooth combo device, etc. In some embodiments, wireless communication system 100 may include more or less peripherals than what is shown in FIG. 1.

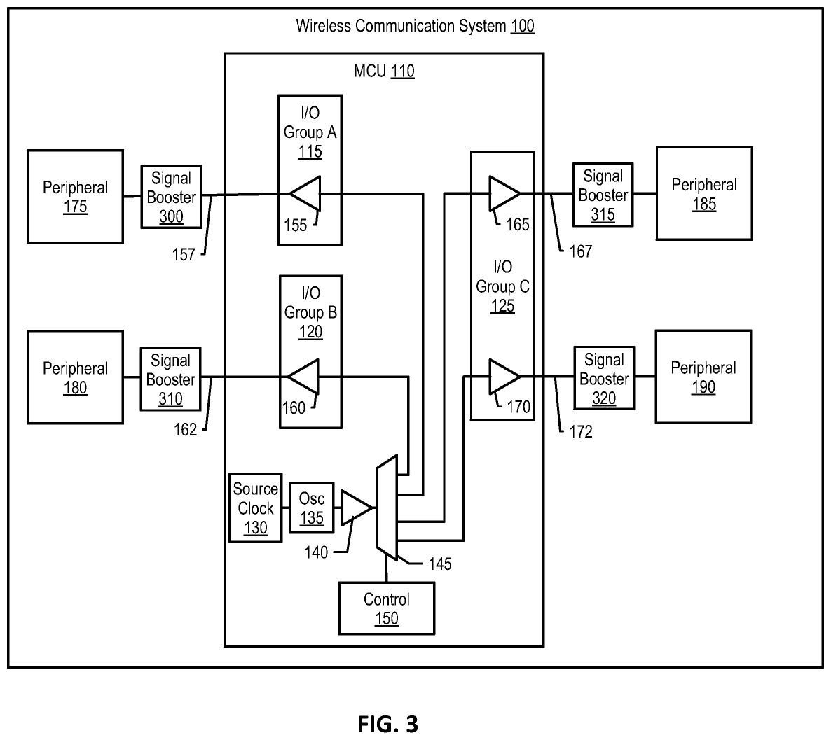

Source clock 130 is external to MCU 110 and produces a source clock signal that feeds into oscillator 135. In some embodiments, source clock 130 is a crystal that produces an analog source clock signal and oscillator 135 converts the analog source clock signal to a digital source clock signal. In some embodiments, source clock 130 is internal to MCU 110 (see FIG. 3 and corresponding text for further details).

The output of oscillator 135 feeds into buffer 140, whose output feeds into multiplexer 145. Control 150 determines to which of the outputs of multiplexer 145 will fan out the source clock signal. In some embodiments, control 150 identifies states of peripherals 175, 180, 185, and 190 (e.g., active state, low power state, etc.) and feeds a corresponding clock signal to their respective buffers 155, 160, 165, and 170. In some embodiments, oscillator 135, buffer 140, and multiplexer 145 operate in a low power domain (e.g., deep sleep mode).

I/O group A 115 includes buffer 155 and may operate in power domain with a 3.3V VDD (Voltage Drain to Drain, power supply voltage). Buffer 155 conditions clock signal 157 (e.g., adjusts voltage level up/down to power domain voltage, etc.) from one of the outputs of multiplexer 145. Clock signal 157 feeds into peripheral 175, and peripheral 175 uses clock signal 157 accordingly, such as for a low power clock signal when peripheral 175 is in a low power state.

Similarly, I/O group B 120 includes buffer 160 and may operate in a power domain with a 1.2V VDD. Buffer 160 produces clock signal 162 from one of the outputs of multiplexer 145. Clock signal 162 feeds into peripheral 180 and peripheral 180 uses clock signal 162 accordingly, such as for a low power clock signal when peripheral 180 is in a low power state.

I/O group C 125 includes buffers 165 and 170 and may operate in a power domain with a 1.8V VDD. Buffer 165 produces clock signal 167 from one of the outputs of multiplexer 145. Clock signal 167 feeds into peripheral 185 and peripheral 185 uses clock signal 167 accordingly, such as for a low power clock signal when peripheral 185 is in a low power state. Buffer 170 produces clock signal 172 from one of the outputs of multiplexer 145. Clock signal 172 feeds into peripheral 190 and peripheral 190 uses clock signal 172 accordingly, such as for a low power clock signal when peripheral 190 is in a low power state.

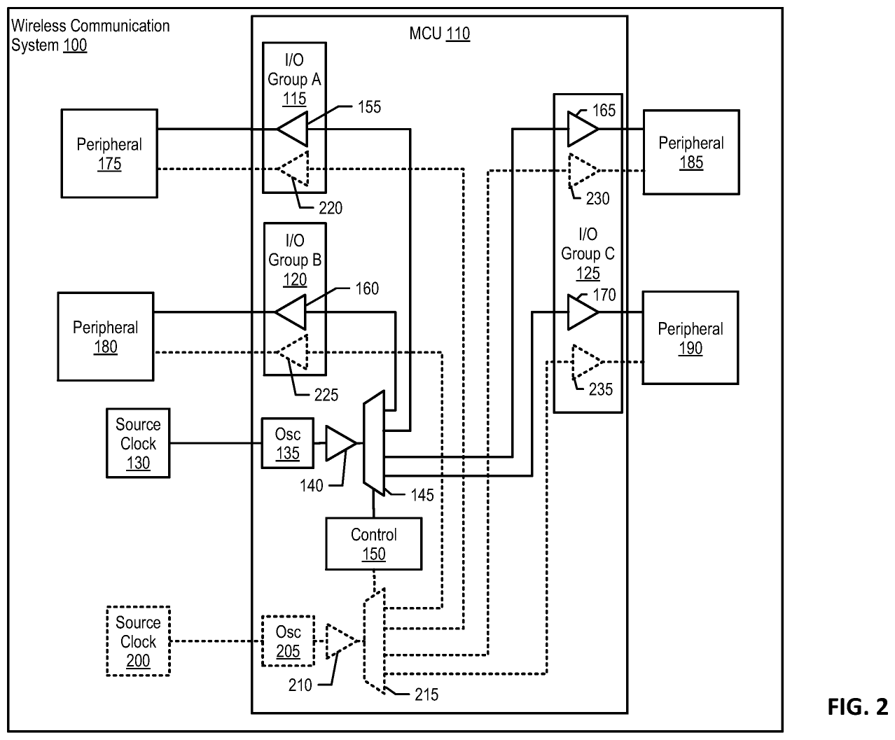

FIG. 2 is a block diagram that illustrates an example system for fanning out multiple source clock signals in multiple clock domains to multiple input/output (I/O) groups corresponding to multiple power domains, in accordance with some embodiments of the present disclosure.

FIG. 2 adds another clock domain to MCU 110 relative to FIG. 1. FIG. 2 shows that MCU 110 couples to peripheral 175, 180, 185, and 190 through I/O group A 215, I/O group B 120, and I/O group C 125. Source clock 130 feeds into oscillator 135, which couples to buffer 140 and produces an input to multiplexer 145. Multiplexer 145 fans out the source clock signal to buffers 155, 160, 165, and 170.

MCU 110 also employs another clock domain using source clock 200 that operates at frequency different from source clock 130, such as a main system clock. Source clock 200 feeds into oscillator 205, which produces a second source clock signal that feeds into buffer 210. Buffer 210 provides an input to multiplexer 215, which is controlled by control 150. Multiplexer 215 fans out the second source clock signal to buffers 220, 225, 230, and 235. The output of these buffers feed to the peripherals as shown in FIG. 2. In some embodiments, source clock 130, source clock 200, or a combination thereof may be internal to MCU 110 (see FIG. 3 and corresponding text for further details.

FIG. 3 is a block diagram that illustrates an example system that includes signal boosters to adjust fanned out clock signals coupled to peripherals, in accordance with some embodiments of the present disclosure.

The system shown in FIG. 3 is similar to that shown in FIG. 1 with the exception of wireless communication system 100 including signal boosters 300, 310, 315, and 320. In some embodiments, an ultra-low power (ULP) host operates in wireless communication system 100. MCU 110 may then be in low-power operation (including interrupt handling) to reduce power consumption of the overall system as peripherals are powered on/off based on MCU 110 instructions. In these embodiments, clock signals 157, 162, 167, and 172 may not be robust enough to support their corresponding power domains. As such, wireless communication system 100 may use signal boosters 300, 310, 315, and 320 to boost clock signals 157, 162, 167, and 172 as they are passed to their corresponding high-power domain peripherals.

In some embodiments, source clock 130 is internal to MCU 110 as shown in FIG. 3. For example, source clock 130 may be an internal low-power oscillator (ILO), an internal main oscillator (IMO), or a combination thereof. An ILO is a built-in clock source that is designed to provide a clock signal for the internal operations of the device, such as timing, synchronization, and data processing. The ILO is often used as a low-power alternative to an external crystal oscillator or other high-frequency clock sources and is optimized for low power consumption. An IMO is an internal clock source that is responsible for generating a main clock signal that drives the overall operation of the device, including the execution of instructions, data processing, and timing functions. The IMO typically operates at a frequency that is determined by internal oscillator circuitry of MCU 110 or integrated circuit. The IMO serves as a self-contained clock source, eliminating the need for an external crystal oscillator or clock generator in the circuit design.

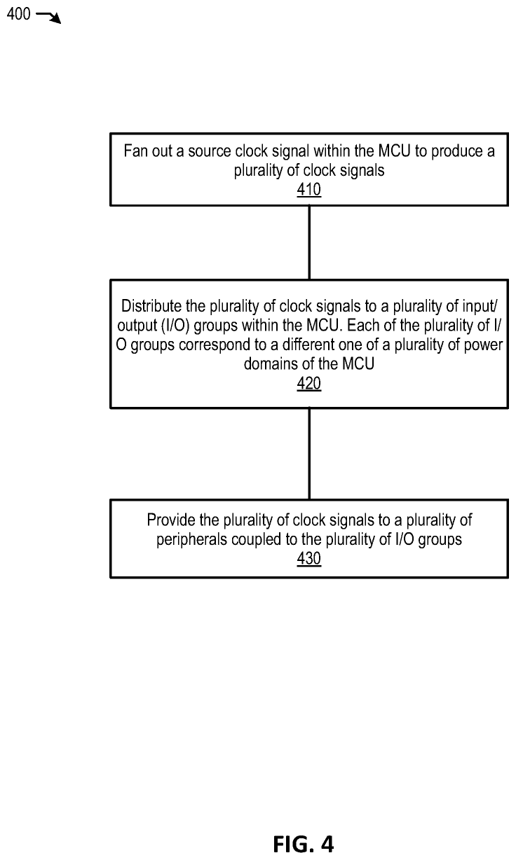

FIG. 4 is a flow diagram of a method 400 for fanning out a source clock signal to multiple input/output (I/O) groups corresponding to multiple power domains, in accordance with some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by control 150, processors 502, processing devices 505, or a combination thereof as shown in FIGS. 1-3 and 5.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, where processing logic fans out a source clock signal within the MCU to produce a plurality of clock signals. In some embodiments, the source clock signal is a first source clock signal corresponding to a first clock domain and the plurality of clock signals are a plurality of first clock signals. In some embodiments, processing logic also fans out a second source clock signal corresponding to a second clock domain within the MCU to produce a plurality of second clock signals. In some embodiments, the first source clock signal and the second source clock signal operate at different clock frequencies (e.g., different clock domains).

At block 420, processing logic distributes the plurality of clock signals to a plurality of input/output (I/O) groups within the MCU 110 that correspond to different power domains of the MCU 110. In some embodiments, processing logic also distributes the plurality of second clock signals to the plurality of I/O groups within the MCU.

At block 430, processing logic provides the plurality of clock signals to a plurality of peripherals coupled to the plurality of I/O groups. In some embodiments, processing logic provides the plurality of second clock signals to the plurality of peripherals coupled to the plurality of I/O groups. In some embodiments, based on the provided clock signal, a peripheral uses the clock signal as a low power clock in a deep sleep mode. In some embodiments, a peripheral uses the clock signal as a main clock signal in operational mode.

In some embodiments, the source clock signal is a low power clock and each one of the plurality of clock signals operates as a low power clock to one or more of the plurality of peripherals while the peripherals are operating at a low power state.

In some embodiments, each one of the plurality of power domains are based on one of a plurality of peripheral specifications corresponding to the plurality of peripherals. In some embodiments, processing logic turns off power to a first peripheral, then turns off one of the plurality of clock signals corresponding to the first peripheral accordingly. In some embodiments, the MCU includes a multiplexer to fan out the source clock signal to produce the plurality of clock signals. In some embodiments, the source clock signal is generated external to the MCU.

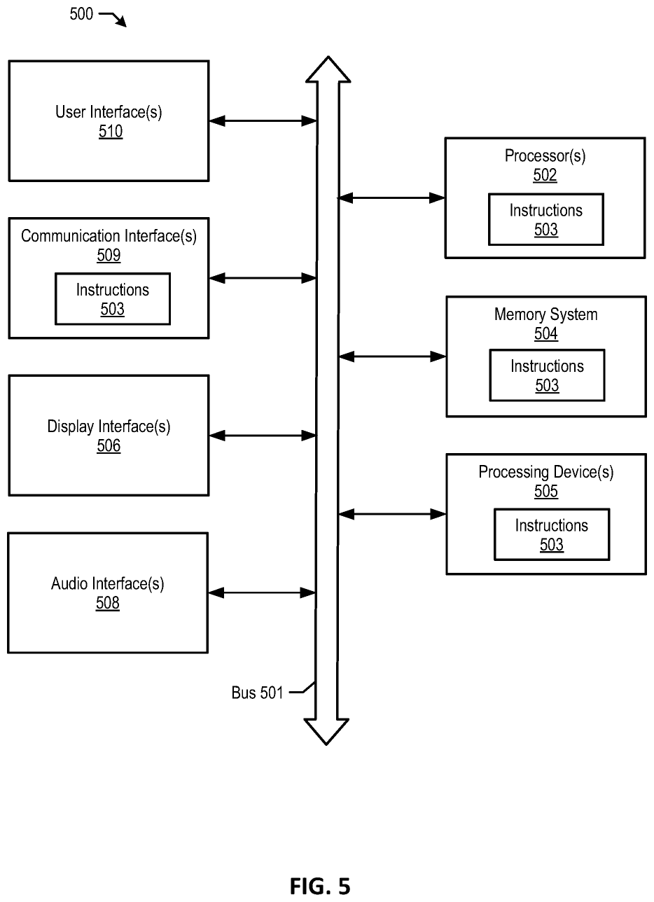

FIG. 5 is a block diagram of an example communication device 500 that may perform one or more of the operations described herein, in accordance with some embodiments of the present disclosure. The communication device 500 may fully or partially include and/or operate the example embodiments or portions thereof as described with respect to FIGS. 1-4. The communication device 500 may be in the form of a computer system (e.g., wireless communication system) within which sets of instructions may be executed to cause the communication device 500 to perform any one or more of the methodologies discussed herein. The communication device 500 may operate as a standalone device or may be connected (e.g., networked) to other machines. In a networked deployment, the communication device 500 may operate in the capacity of a server or a client machine in server-client network environment, or as a peer machine in a P2P (or distributed) network environment.

The communication device 500 may be an Internet of Things (IoT) device, a server computer, a client computer, a personal computer (PC), a tablet, a set-top box (STB), a voice controlled hub (VCH), a Personal Digital Assistant (PDA), a mobile telephone, a web appliance, a network router, switch or bridge, a television, speakers, a remote control, a monitor, a handheld multi-media device, a handheld video player, a handheld gaming device, or a control panel, or any other machine capable of executing a set of instructions (sequential or otherwise) that specify actions to be taken by that machine. Further, while only a single communication device 500 is illustrated, the term “device” shall also be taken to include any collection of machines that individually or jointly execute a set (or multiple sets) of instructions to perform any one or more of the methodologies discussed herein.

The communication device 500 is shown to include processor(s) 502. In embodiments, the communication device 500 and/or processors(s) 502 may include processing device(s) 505 such as a System on a Chip (SoC) processing device. Alternatively, the communication device 500 may include one or more other processing devices known by those of ordinary skill in the art, such as a microcontroller unit (e.g., MCU 110), a microprocessor or central processing unit, an application processor, a host controller, a controller, special-purpose processor, digital signal processor (DSP), an application specific integrated circuit (ASIC), a field programmable gate array (FPGA), or the like. Bus system 501 may include a communication block (not shown) to communicate with an internal or external component, such as an embedded controller or an application processor, via communication interfaces(s) 509 and/or bus system 501.

Components of the communication device 500 may reside on a common carrier substrate such as, for example, an IC die substrate, a multi-chip module substrate, or the like. Alternatively, components of the communication device 500 may be one or more separate ICs and/or discrete components.

The memory system 504 may include volatile memory and/or non-volatile memory which may communicate with one another via the bus system 501. The memory system 504 may include, for example, random access memory (RAM) and program flash. RAM may be static RAM (SRAM), and program flash may be a non-volatile storage, which may be used to store firmware (e.g., control algorithms executable by processor(s) 502 to implement operations described herein). The memory system 504 may include instructions 503 that when executed perform the methods described herein. Portions of the memory system 504 may be dynamically allocated to provide caching, buffering, and/or other memory based functionalities.

The memory system 504 may include a drive unit providing a machine-readable medium on which may be stored one or more sets of instructions 503 (e.g., software) embodying any one or more of the methodologies or functions described herein. The instructions 503 may also reside, completely or at least partially, within the other memory devices of the memory system 504 and/or within the processor(s) 502 during execution thereof by the communication device 500, which in some embodiments, constitutes machine-readable media. The instructions 503 may further be transmitted or received over a network via the communication interfaces(s) 509.

While a machine-readable medium is in some embodiments a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the example operations described herein. The term “machine-readable medium” shall accordingly be taken to include, but not be limited to, solid-state memories, and optical and magnetic media.

The communication device 500 is further shown to include display interface(s) 506 (e.g., a liquid crystal display (LCD), touchscreen, a cathode ray tube (CRT), and software and hardware support for display technologies), audio interface(s) 508 (e.g., microphones, speakers and software and hardware support for microphone input/output and speaker input/output). The communication device 600 is also shown to include user interface(s) 510 (e.g., keyboard, buttons, switches, touchpad, touchscreens, and software and hardware support for user interfaces).

Unless specifically stated otherwise, terms such as “fanning,” “distributing,” “providing,” “turning,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first” and “second” as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method performed by an electronic circuit within a microcontroller unit (MCU), the method comprising:
fanning out a source clock signal within the MCU to produce a plurality of clock signals;
distributing the plurality of clock signals to a plurality of input/output (I/O) groups within the MCU, wherein each one of the plurality of I/O groups correspond to a different one of a plurality of power domains of the MCU; and
providing the plurality of clock signals to a plurality of peripherals coupled to the plurality of I/O groups.

2. The method of claim 1, wherein the source clock signal is a first source clock signal corresponding to a first clock domain and the plurality of clock signals are a plurality of first clock signals, the method further comprising:
fanning out a second source clock signal corresponding to a second clock domain within the MCU to produce a plurality of second clock signals, wherein the first source clock signal and the second source clock signal operate at different clock frequencies;
distributing the plurality of second clock signals to the plurality of I/O groups; and
providing the plurality of second clock signals to the plurality of peripherals coupled to the plurality of I/O groups.

3. The method of claim 1, wherein the source clock signal is a low power clock and each one of the plurality of clock signals operate as a low power clock to one or more of the plurality of peripherals while operating a low power state.

4. The method of claim 1, wherein each one of the plurality of power domains are based on one of a plurality of device specifications corresponding to the plurality of peripherals.

5. The method of claim 1, further comprising:
turning off power to a first peripheral of the plurality of peripherals; and
turning off one of the plurality of clock signals corresponding to the first peripheral in response to turning off the power to the first peripheral.

6. The method of claim 1, wherein the MCU comprises a multiplexer to fan out the source clock signal to produce the plurality of clock signals.

7. The method of claim 1, wherein the source clock signal is generated external to the MCU.

8. A system comprising a microcontroller unit (MCU), configured to:
fan out a source clock signal to produce a plurality of clock signals;
distribute the plurality of clock signals to a plurality of input/output (I/O) groups within the MCU, wherein each of the plurality of I/O groups correspond to a different one of a plurality of power domains of the MCU; and
provide the plurality of clock signals to a plurality of peripherals coupled to the plurality of I/O groups and external to the MCU.

9. The system of claim 8, wherein the source clock signal is a first source clock signal that corresponds to a first clock domain and the plurality of clock signals are a plurality of first clock signals, the MCU further configured to:
fan out a second source clock signal that corresponds to a second clock domain within the MCU to produce a plurality of second clock signals, wherein the first source clock signal and the second source clock signal operate at different clock frequencies;
distribute the plurality of second clock signals to the plurality of I/O groups; and
provide the plurality of second clock signals to the plurality of peripherals coupled to the plurality of I/O groups.

10. The system of claim 8, further comprising:
one or more clock signal boosters that adjust a voltage level of one or more of the plurality of clock signals prior to being sent to one or more of the plurality of peripherals.

11. The system of claim 8, wherein each one of the plurality of power domains are based on one of a plurality of device specifications corresponding to the plurality of peripherals.

12. The system of claim 8, wherein the MCU is further configured to:
turn off power to a first peripheral of the plurality of peripherals; and
turn off one of the plurality of clock signals that correspond to the first peripheral based on the power turned off to the first peripheral.

13. The system of claim 8, wherein the MCU comprises a multiplexer to fan out the source clock signal to produce the plurality of clock signals.

14. The system of claim 8, wherein the source clock signal is generated external to the MCU.

15. A microcontroller unit (MCU), configured to:
fan out a source clock signal to produce a plurality of clock signals;
distribute the plurality of clock signals to a plurality of input/output (I/O) groups within the MCU, wherein each of the plurality of I/O groups correspond to a different one of a plurality of power domains of the MCU; and
provide the plurality of clock signals to a plurality of peripherals coupled to the plurality of I/O groups and external to the MCU.

16. The MCU of claim 15, wherein the source clock signal is a first source clock signal that corresponds to a first clock domain and the plurality of clock signals are a plurality of first clock signals, the MCU further configured to:
fan out a second source clock signal that corresponds to a second clock domain within the MCU to produce a plurality of second clock signals, wherein the first source clock signal and the second source clock signal operate at different clock frequencies;
distribute the plurality of second clock signals to the plurality of I/O groups; and
provide the plurality of second clock signals to the plurality of peripherals coupled to the plurality of I/O groups.

17. The MCU of claim 15, wherein the source clock signal is a low power clock and each one of the plurality of clock signals operate as a low power clock to one or more of the plurality of peripherals while operating a low power state.

18. The MCU of claim 15, wherein each one of the plurality of power domains are based on one of a plurality of device specifications corresponding to the plurality of peripherals.

19. The MCU of claim 15, wherein the MCU is further configured to:
turn off power to a first peripheral of the plurality of peripherals; and
turn off one of the plurality of clock signals that correspond to the first peripheral based on the power turned off to the first peripheral.

20. The MCU of claim 15, wherein the MCU comprises a multiplexer to fan out the source clock signal to produce the plurality of clock signals.
